(19) United States
(12) Patent Application Publication
(10) Pub. No.: US 2005/0103721 A1
(43) Pub. Date: May 19, 2005

(54) Reduced pressure water filtration system

(76) Inventor: Karl Fritze, Denmark Township, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/948,081

(22) Filed: Sep. 23, 2004

Related U.S. Application Data
(60) Provisional application No. 60/505,152, filed on Sep. 23, 2003.

(51) Int. Cl. B01D 36/00

(52) U.S. Cl. 210/744; 210/767; 210/104; 210/282

(57) ABSTRACT

A reduced pressure water filtration system provides for water filtration at a pressure lower than line pressure while preventing exposure of the reduced pressure water filtration system to potentially damaging static pressures such that the system and components are exposed to significantly less water pressure. The reduced pressure water filtration system can comprise a distribution module, at least one filter element, a filtered water storage module and a control unit. The filtered water storage module and the control unit may or may not be physically connected with the distribution manifold and/or filter element. A downstream side of the reduced pressure water filtration system is vented to atmosphere such that closing an inlet valve to the reduced pressure water filtration system in a non-flow mode results in any static pressure being vented.

### PRIORITY CLAIM

The present application claims priority to U.S. Provisional Application No. 60/505,152, entitled, “REDUCED PRESSURE WATER FILTRATION SYSTEM,” filed Sep. 23, 2003, the disclosure of which is hereby incorporated by reference to the extent not inconsistent with the present disclosure.

### BACKGROUND OF THE DISCLOSURE

The present disclosure relates generally to the field of water filtration systems. More specifically, the present invention relates to a water filtration system, such as those used in consumer residences, designed to operate at pressure lower than line pressure and preventing exposure of the water filtration system to potentially damaging static pressure during periods of non-use.

Water filtration systems designed for use in the home, such as, for example, refrigerator and under-sink systems can be used to remove contaminants from water supplies. Due to increasing quality and health concerns with regard to municipal and well-water supplies, the popularity of such filtration systems has increased markedly in recent years. For example, the inclusion of water filtration systems in refrigerators, once considered a luxury feature, is now included as a standard feature in all but entry level refrigerator designs.

A typical residential water filtration system generally includes a distribution manifold configured to accept a (prepackaged) specifically designed cartridge filter. The distribution manifold is typically adapted to operatively connect either directly or indirectly to the residential water supply and to points of use and may even allow for a drain connection. Generally, the prepackaged specifically designed cartridge filter sealingly engages the distribution manifold such that an inlet flow channel connects the residential water supply and the cartridge filter, and at least one outlet flow channel connects the cartridge filter and the points of use and/or the drain.

Typical residential water filtration systems have an inlet valve on the upstream side of the filter as well at least one distribution valve on the downstream side of the system. The inlet valve may be an electrically actuated valve that is open only when filtered water is requested or it may be a manual valve that is generally left in an open position except during installation and replacement of the filter system or an individual filter element. The at least one distribution valve can be closed when the system is not in use and is opened when filtered water is manually requested by a user or automatically requested by another system such as an ice maker. Through the use of the distribution valve as a control of flow, water filtration systems are exposed to residential line pressure up to the distribution valve to provide a driving force for quickly dispensing filtered water upon request.

### SUMMARY OF THE INVENTION

A representative reduced pressure water filtration system of the present disclosure provides for water filtration at a pressure lower than line pressure while preventing exposure of the reduced pressure water filtration system to potentially damaging static pressures such that the system and components are exposed to significantly less water pressure. Generally, the reduced pressure water filtration system can comprise, in a presently preferred arrangement, a distribution module, at least one filter element, a filtered water storage module and a control unit. The filtered water storage module and the control unit may or may not be physically connected with the distribution manifold and/or filter element.

The distribution manifold can comprise an inlet port, at least one outlet port and an interface adapted to sealingly engage the at least one filter element. The distribution manifold can further comprise an inlet valve, a flow sensor and an outlet diverter valve. In some representative embodiments, the distribution manifold can comprise multiple interfaces for attaching a plurality of filter elements, either in a series or parallel flow arrangement. The various elements of the distribution manifold, such as the inlet valve, may or may not be part of a unitary structure. For example, the inlet valve can be mounted along an inlet line leading to a filter connector.

In some representative embodiments, a filter element can be a specifically designed sealed cartridge filter that can comprise a filter housing, an internal filtering media and a filter cap adapted to sealingly engage an interface of the distribution manifold. The filter housing may take the form, for example, of a cylinder or may comprise a generally, flat or rectangular orientation. The internal filtering media may be any suitable water filtering media, for example, powdered and granular activated carbon media, ceramic filtration media, powdered polymeric filtration media, manganese greensand, ion exchange media, cross flow filtration media, polymeric barrier filtration media, mineral-based fibers, granules and powders, or other appropriate filter mediums.

The filtered water storage module may take the form, for example, of a tank or a removable pitcher. In some representative embodiments, the filtered water storage module can comprise a water level sensor and/or a proximity or positioning sensor. In one alternative embodiment, the tank may have a distribution valve adapted for manual operation by a user. In another alternative embodiment, the removable pitcher may have a handle to facilitate removal and handling by a user.

In some representative embodiments, the control unit facilitates communication between the distribution manifold and the filtered water storage module. The control unit may comprise a Programmable Logic Controller (PLC), a microprocessor, an electronic logic circuit comprising switches and relays, or a terminal strip. The control unit may be unique to the reduced pressure water filtration system or may be a centralized module responsible for control of other systems such as might be used in a “smart” appliance such as refrigerator integrated to a home network or the internet. The control unit may communicate and/or control a variety of control elements such as an inlet valve, a flow sensor, a diverter valve, a level sensor and a proximity or positioning sensor.

In one embodiment of the reduced pressure water filtration system, a downstream side of the reduced pressure water filtration system is continually vented to atmosphere such that a static pressure in a non-flow mode never exceeds atmospheric pressure. The downstream side can comprise a diverter valve that selectively diverts flow through a desired distribution circuit, for example to a storage tank, a filtered water tap or spigot, an icemaker and combinations thereof. In a non-flow mode, an inlet valve can close to prevent inlet flow to the reduced pressure water filtration system while any static pressure within the reduced pressure water filtration system is vented.

In another embodiment of a reduced pressure water filtration system, the system provides an increased avoidance of freeze induced failure. Since the filtered water storage is downstream from the filter, components, for example the distribution manifold and the at least one filter element, can be physically located outside of refrigerated areas such that these elements are not exposed to freezing temperatures. Also, as will be described in detail below, the reduced pressure water filtration system can encourage ongoing, low volume water flow such that the formation of ice crystals is discouraged, although there can be flow stoppages. Components also have increased chances of surviving freezing as they are never exposed to a high pressure environment. In such a reduced pressure environment, components remain in a relatively unexpanded and unstressed state allowing for a greater amount of expansion, as compared to a high pressure system, should a freezing condition occur. In some representative embodiments, components comprising the reduced pressure water filtration system may require less heavy-duty construction, for example reduced wall thicknesses, resulting in reduced material costs as the potential for exposure to freeze induced stresses, and/or stresses from higher water pressure can be significantly reduced. By incorporating freeze resistant design elements, the reduced pressure water filtration systems of the present invention can be structurally safer than existing systems as there is a reduced burst danger.

In yet another embodiment of a reduced pressure water filtration system, the system can provide a relatively large volume of immediately available, chilled and filtered water. In one embodiment, the reduced pressure water filtration system comprises a large volume reservoir, such as a removable pitcher, mounted within a refrigerated chamber such that the volume of filtered water in the reservoir is continually chilled when mounted in the refrigerated chamber. In the case of a removable pitcher, the pitcher may be removed for use such that a user can individually pour glasses of water or for use in cooking or other domestic uses. A further advantage of a removable pitcher is an opportunity to routinely clean and sanitize the pitcher. In another embodiment, the reservoir comprises a large volume water tank comprising a distribution valve such that a user can access the chilled, filtered water from the tank on demand. In yet another embodiment, a reduced pressure water filtration system can comprise a pump to boost and facilitate delivery of filtered water within a water distribution circuit.

In another aspect of the present disclosure, a reduced pressure water filtration system provides design flexibility in devising filtration methodologies based upon user preferences or the source water filter quality. For example, by operating at low pressure and consequently a low flow rate, the quality of the filtered water can be increased due to increased contact time and reduced channeling within the filtering media. In an example of a system utilizing a plurality of filter elements, a prefilter, such as activated carbon or greensand, can pretreat the source water, a second element utilizing reverse osmosis media can remove dissolved solids and a polishing element can remove remaining ionic, organic and/or biological contaminants. In another embodiment, multiple filter elements can be utilized in parallel to increase the filtering speed of the reduced pressure water filtration system. In another example, a reduced pressure water filtration system can provide for a high filtration rate at line pressure while preventing the possibility of high static pressures in non-flow conditions by continually exposing the outlet to atmosphere.

The above summary of the various aspects of the present disclosure is not intended to describe in detail each illustrated embodiment or the details or every implementation of the present disclosure. The figures in the detailed description that follow more particularly exemplify these representative embodiments. These, as well as other objects and advantages of the present disclosure, will be more completely understood and appreciated by referring to the following more detailed description of the described representative, exemplary embodiments of the present disclosure in conjunction with the accompanying drawings.

### BRIEF DESCRIPTION OF THE DRAWINGS

FIG. 1 is a schematic view of a representative embodiment of a reduced pressure water filtration system.

FIG. 2 is a schematic view of another representative embodiment of a reduced pressure water filtration system.

FIG. 3 is a partial section view of a representative installation of the reduced pressure water filtration system of FIG. 1 in an appliance.

FIG. 4 is a partial section view of another representative installation of the reduced pressure water filtration system of FIG. 1 in an appliance.

### DETAILED DESCRIPTION OF THE PREFERRED EMBODIMENTS

A reduced pressure water filtration system for use in conjunction with an appliance, such as a refrigerator or water dispenser, generally can comprise a distribution manifold, at least one filter element, a storage module and a control unit. In some representative embodiments, the distribution manifold, at least one filter element and optionally the control unit can be physically located outside of a refrigerated chamber to limit system exposure to freezing conditions or to save interior space. The distribution manifold can be adapted for use with a plurality of filter elements, plumbed in series or parallel, allowing flexibility with respect to overall filtration quality as well as filtration capacity. The reduced pressure water filtration system can offer a number of advantages, for example, a freeze-resistant design, increased filtration versatility and a large volume of on-demand filtered and chilled water. By designing the system to generally operate at lower pressures, the filter can be correspondingly designed with a thinner wall or with less expensive materials such that material costs can be significantly reduced.

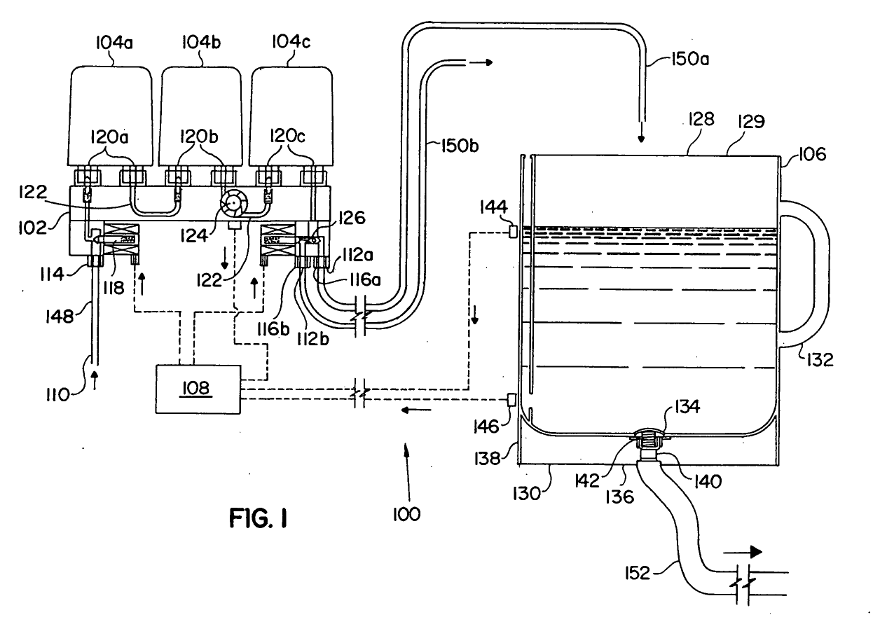

As depicted in FIG. 1, an embodiment of a reduced pressure water filtration system 100 comprises a distribution manifold 102, a plurality of filter elements 104a, 104b, 104c, a storage tank 106 and a control module 108. As depicted, reduced pressure water filtration system 100 has an inlet water source 110 and a pair of filtered water outlets 112a, 112b. In some representative embodiments, distribution manifold 102, filter elements 104a, 104b, 104c and control unit 108 are physically located outside of a refrigerated chamber while storage tank 106 resides within a refrigerated chamber. Filter elements 104a, 104b, 104c are shown connected in series such that the output of one valve is the input of the next valve in the series. While, three filter elements are shown connected in series, a great number or lesser number, such as two, can be used as desired.

Distribution manifold 102 comprises an inlet connection 114 and a pair of outlet connections 116a, 116b. An inlet valve 118 can be located in proximity to inlet connection 114. Inlet valve 118 can comprise a separate component mounted upstream of the distribution manifold 102 or may comprise an integral component to the distribution manifold. Inlet valve 118 can comprise an actuated valve assembly operably connected to the control module 108. Inlet valve 118 can be actuated, for example electrically, pneumatically or hydraulically at the direction of control module 108. Inlet valve 118 can comprise any suitable flow valve such as a solenoid valve, a ball valve, a diaphragm valve, a gate valve, a needle valve and the like. Inlet valve 118 can include an orifice, such as a choked-flow orifice or a deformable orifice, to reduce or throttle a water inlet pressure to below a predetermined maximum pressure such that operation of the water filtration system 100 occurs below the predetermined maximum pressure. In another alternative embodiment, inlet valve 118 can comprise a pressure regulating valve to throttle or reduce the water inlet pressure. Examples of suitable pressure regulating or pressure reducing valves include pressure regulating valves as manufactured by Honeywell International Inc., of Morris Township, N.J., and by George Fischer Ltd., of Schaffhausen, Switzerland. Inlet valve 118 can be configured to throttle the water inlet pressure so as to provide a dynamic filtering pressure from about 10 psig to about 120 psig.

Distribution manifold 102 is further adapted to sealingly engage with filter elements 104a, 104b, 104c at a filter connection 120a, 120b, 120c. Distribution manifold 102 comprises an internal flow channel 122, which fluidly connects filter connections 120a, 120b, 120c in series. Distribution manifold 102 can comprise a flow sensor 124 mounted within the internal flow channel 122 and electrically connected to control unit 108. Distribution manifold 102 can also comprise a two-position diverter valve 126 just prior to outlet connections 116a, 116b and electrically connected to control unit 108 to selectively direct flow among two or more alternative outlet connections. Alternatively, distribution manifold 102 can include an outlet valve mounted in proximity to each outlet connection 116a, 116b, wherein at least one of said outlet valves is always in an open position.

Filter elements 104a, 104b, 104c can comprise preassembled filter assemblies and corresponding filter connections for sealing engagement, for example through rotatable or linear interconnection, with distribution manifold 102. Examples of suitable filter assemblies and connections for use in rotatable, sealing engagement are disclosed in U.S. patent application Ser. Nos. 09/618,686, 09/918,316, 10/196,340, 10/202,290 and 10/406,637 while assemblies and connections for slidable engagement are disclosed in U.S. patent application Ser. No. 10/210,890, each of the preceding applications being incorporated by reference to the extent not inconsistent with the present disclosure. Filter elements 104a, 104b, 104c can comprise any suitable water filtration media such as powdered and granular activated carbon media, ceramic filtration media, powdered polymeric filtration media, manganese greensand, ion exchange media, cross flow filtration media, polymeric barrier filtration media, mineral-based fibers, granules and powders, or other appropriate filter mediums. For purposes of describing an example of the use and function of reduced pressure water filtration system 100 as illustrated in FIG. 1, filter element 104a can include a melt-blown polypropylene prefilter, filter element 104b can comprise an activated carbon filter and filter element 104c can comprise a deionizing filter having a suitable mixture of anion and cation exchange resins.

Filtration manifold 102 can include features allowing for removal and replacement of filter elements 104a, 104b, 104 such that water leakage is substantially reduced or eliminated during maintenance of the water filtration system 100. For example, filtration manifold 102 can include a spring valve mounted within an inlet stream to each filter element 104a, 104b, 104c. The spring valve selectively allows flow when a filter element is attached to the filtration manifold 102 and prevents flow when a filter element is not attached to the filtration manifold. Examples of suitable flow arrangements and engagement mechanisms utilizing spring valves are disclosed and described within the applications previously incorporated by reference.

In another alternative arrangement, filter elements 104a, 104b, 104c can include a self-disengagement mechanism whereby the filter elements 104a, 104b, 104c purposely disengage from the distribution manifold 102 at pressures above a desired maximum dynamic filtration pressure. For example, arrangements utilizing a rotatable sealing engagement to attach the filter elements 104a, 104b, 104c to the distribution manifold 102, for example through the interaction of angled ramps, circumferential ramps and tabs, can include frictional engagement members on the filter elements 104a, 104b, 104c and distribution manifold 102 such that filter elements rotatably disengage, or back drive, from the distribution manifold 102 above a desired maximum dynamic filtration pressure, for example as described in U.S. patent application Ser. No. 10/202,290, filed Jul. 24, 2002 and entitled, “HOT DISCONNECT REPLACEABLE WATER FILTER ASSEMBLY,” the preceding application being incorporated by reference to the extent not inconsistent with the present disclosure. Frictional engagement members can include variations such as a protrusion on the filter element ramp and a notch or divot on the distribution manifold ramp wherein the protrusion and divot frictionally are frictionally engaged when the filter element and distribution manifold are connected. The amount of frictional engagement can be controlled such that dynamic filtration pressures above a desired maximum overcome this frictional engagement such that filter element rotationally disengages from the distribution manifold, wherein the aforementioned spring valve can close to prevent leakage, preventing exposure of the filter elements to pressures above the desired maximum dynamic pressure.

In arrangements in which water filtration system 100 comprises at least one filter element designed for cross flow filtration, for example filter element 104b including a membrane filtration media for microfiltration, ultrafiltration, nanofiltration or reverse osmosis filtration, the filter element 104b and distribution manifold 102 can be configured to interconnect and form permeate and concentrate flow channels as described in U.S. patent application Ser. No. 10/838,140, filed May 3, 2004 and entitled “CROSSFLOW FILTRATION SYSTEM WITH QUICK DRY CHANGE ELEMENTS”, which is hereby incorporated by reference to the extent not inconsistent with the present disclosure.

Storage tank 106 can comprise any suitable water reservoir configuration, such as a tank or a length of tubing capable of acting as a heat exchanger. As illustrated in FIG. 1, storage tank 106 is depicted in the form of removable pitcher 128 mounted within a support structure 130. Removable pitcher 128 can have, for example, an open top 129, a handle 132 and an outlet port 134, although other configurations are contemplated. Pitcher 128 can be manufactured of a transparent or translucent polymeric material to provide a user with a visible indication of the amount of water present. Removable pitcher 128 may have markings for indicating the volume of water present within the pitcher. In some embodiments, storage tank 106 may have a filtered water capacity of 0.5-1.0 gallons. Support structure 130 comprises a floor 136 and a perimeter wall 138. Floor 136 includes a distribution port 140 adapted to interface with a check valve 142 integrally mounted within outlet port 134. Support structure 130 further comprises a level sensor 144 and a proximity sensor 146, both adapted to interface with the pitcher 128 and electrically connected to control unit 108. Level sensor 144 can comprise any suitable level sensor capable of communicating a water level in the storage tank 106 to the control unit 108 such as a float switch, a pressure transducer, an ultrasonic level sensor, an optical sensor, or a capacitance measurement switch.

Control unit 108 may comprise a microprocessor, a programmable logic controller (PLC), an electronic logic circuit comprising switches and relays and/or a plurality of contacts on a terminal strip. Generally, inlet valve 118, flow sensor 124, diverter valve 126, level sensor 144 and proximity sensor 146 are communicably connected to control unit 108, which may be located at one position or have components at several locations. Based on inputs received from flow sensor 124, level sensor 144, proximity sensor 146 and any other inputs associated with or external to the reduced pressure water filtration system 100, control unit 108 controls operation of inlet valve 118. Control unit 108 may be a unique component of the reduced pressure water filtration system 100 or may be an appliance control unit controlling multiple systems.

When fully assembled, a length of inlet tubing 148 can fluidly connect inlet water source 110 with inlet connection 114, a length of outlet tubing 150a can fluidly connect the filtered water outlet 112a to open top 129, a length of outlet tubing 150b can fluidly connect the filtered water outlet 112b to an alternative point of use, for example an automatic ice maker, and a length of delivery tubing 152 can fluidly connect the distribution port 140 to a faucet or other point of use.

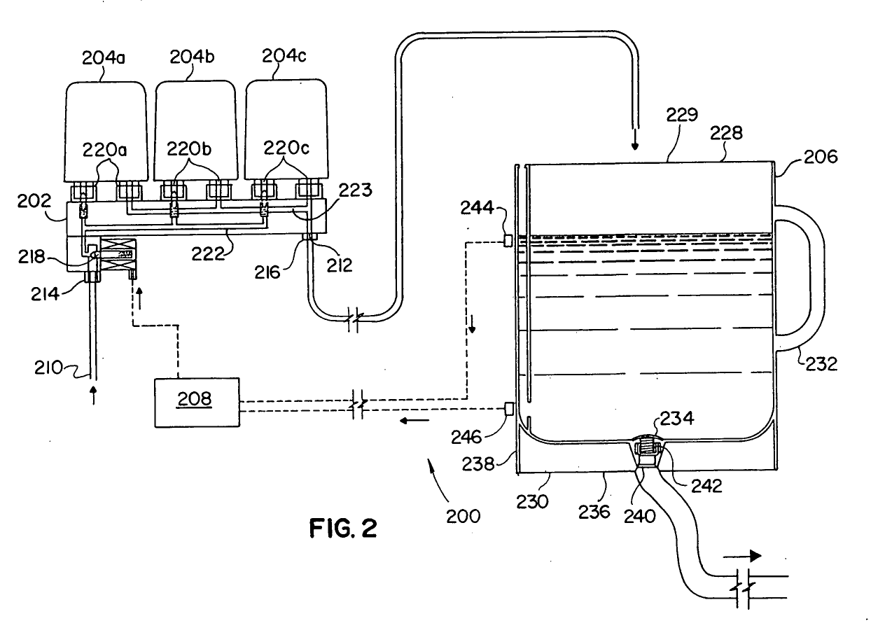

As depicted in FIG. 2, an embodiment of a reduced pressure water filtration system 200 comprises a distribution manifold 202, a plurality of filter elements 204a, 204b, 204c, a storage tank 206 and a control module 208. As depicted, reduced pressure water filtration system 200 has an inlet water source 210 and a filtered water outlet 212. Distribution manifold 202, filter elements 204a, 204b, 204c and control module 208 can be physically located outside of a refrigerated chamber while storage tank 206 resides within a refrigerated chamber.

Distribution manifold 202 comprises an inlet connection 214 and an outlet connection 216. Located at inlet connection 214 is an inlet valve 218 wired to control unit 208. Distribution manifold 202 is further adapted to sealingly engage with filter elements 204a, 204b, 204c at a filter connection 220a, 220b, 220c. Filter connection 220a, 220b, 220c can take the form of a single connection point or an inlet and outlet point as depicted. Distribution manifold 202 comprises an internal supply flow channel 222 and an internal distribution flow channel 223 that fluidly connects filter connections 220a, 220b, 220c in parallel such that the filtration capacity is increased by flowing the water through a plurality of filters. Although, the system is depicted with three filter elements, a larger number or smaller number, such as two, of filter elements can be used. In addition, a combination of filter elements in series and parallel can be used, such as two-pairs of filter elements with each pair of elements connected in series and the pairs being connected in parallel relative to each other.

Filter elements 204a, 204b, 204c can comprise preassembled filter assemblies such as those previously disclosed, although other suitable filter elements can be used. Filter elements 204a, 204b, 204c can be adapted to sealingly engage filter connections 220a, 220b, 220c either rotatably or slidingly as previously disclosed. Filter elements 204a, 204b, 204c can comprise any suitable water filtration media such as manganese greensand, activated carbon, reverse osmosis membranes or ion exchange resin. For purposes of describing the use and function of reduced pressure water filtration system 200, filter elements 204a, 204b, 204c include activated carbon media.

Storage tank 206 is again depicted in the form of removable pitcher 228 mounted within a support structure 230, though any suitable reservoir configuration could be used. Removable pitcher 228 comprises, for example, an open top 229, a handle 232 and an outlet port 234. Pitcher 228 can be manufactured of a transparent or translucent polymeric material to provide a user with a visible indication of the amount of water present. Removable pitcher 228 may comprise markings for indicating the volume of water present within the pitcher 228. Support structure 230 comprises a floor 236 and a perimeter wall 238. Floor 236 includes a distribution port 240 adapted to interface with a check valve 242 integrally mounted within outlet port 234. Support structure 230 further comprises a level sensor 244 and a proximity sensor 246, both adapted to interface with the pitcher 228 and electrically connected to control unit 208.

Control unit 208 may comprise a programmable logic controller (PLC), a microprocessor, an electronic logic circuit comprising switches and relays and/or a plurality of contacts on a terminal strip. Generally, inlet valve 218, level sensor 244 and proximity sensor 246 are electrically connected to control unit 208. Based on inputs received from level sensor 244, proximity sensor 246 and any other inputs associated with or external to reduced pressure water filtration system 200, control unit 208 can control operation of inlet valve 218. Control unit 208 may be a unique component of the reduced pressure water filtration system 200 or may comprise a controller used to control multiple systems.

When fully assembled, a length of inlet tubing 248 can fluidly connect inlet water source 210 with inlet connection 214, a length of outlet tubing 250 can run from filtered water outlet 212 to open top 229 and a length of delivery tubing 252 can run from distribution port 240 to a faucet or other point of use.

In use, reduced pressure water filtration system 100 filters inlet water source 110 and distributes filtered water through filtered water outlets 112a, 112b. Inlet water source 110 flows through inlet tubing 148, inlet connection 114, past inlet valve 118 and into distribution manifold 102. In one representative embodiment, inlet valve 118 may comprise an orifice or other restriction such that the pressure of inlet water source 110 is significantly reduced prior to entering the distribution manifold 102. Inlet valve 118 can be used to reduce an inlet flow rate, for example 0.5 gallons per minute (gpm) to 0.5 gallons per hour (gph) of water flow, such that contact time within filter elements 104a, 104b, 104c is increased. Increased contact time with the filter media can have advantages including, for example, high filtering or contaminant removal efficiencies with a reduced media volume as compared to high flow rate designs.

Within distribution manifold 102, the water to be filtered is directed serially through filter elements 104a, 104b, 104c via internal flow channels 122. In some representative embodiments described above, filter element 104a can remove particulates, filter element 104b can remove chlorine and dissolved organic materials, and filter element 104c removes dissolved ionic impurities. In some representative embodiments, filter element 104c can comprise a taste cartridge designed to impart certain desirable minerals and/or flavors to improved upon the taste of the filtered water. As water flows through internal flow channel 122, flow sensor 124 transmits flow rates to the control unit 108.

When the filtered water exits filter element 104c, the water is directed through either filtered water outlet 112a or 112b depending upon the position of diverter valve 126. Diverter valve 126 can be positioned based on a signal from the control unit 108, possibly based on an external demand input. When filtered water is directed through filtered water outlet 112a, the water flows out of outlet connection 116a, into outlet tubing 150a where it subsequently flows through open top 129 and into removable pitcher 128. When filtered water is directed through filtered water outlet 112b, the water flow out of outlet connection 116b, into outlet tubing 150b where it flows into a point of use such as an automatic icemaker.

When desired, a user can access the filtered water in a variety of ways, which can be different for different representative embodiments. First, the user can access the water through a tap or spigot, for example in a refrigerator door, whereby filtered water flows though outlet port 134, past check valve 142 and through delivery tubing 152 to point of use. Alternatively, a user can grasp handle 132 and carry removable pitcher 128 to a point where filtered water is to be used. When removable pitcher 128 is removed from support structure 130, check valve 142 prevents water leakage from outlet port 134. At the same time, proximity sensor 146 sends a signal to control module 108 such that filtered water is not directed to through outlet tubing 150a while removable pitcher 128 is not present.

Control unit 108 can comprise a logic circuit for operating reduced pressure water filtration system 100. Based upon a demand input from the level sensor 144 or at the request of an alternative point of use, such as a door mounted spigot or tap or an icemaker, control unit 108 opens the inlet valve 118 and positions diverter valve 126 such that filtered water is directed to the appropriate destination. If filtered water is being directed to removable pitcher 128, control unit 108 can stop further water filtration based upon a high level indication from the level sensor 144 or if removable pitcher 128 has been removed, based on a signal from the proximity sensor 146. Control unit 108 may continuously monitor and track volumetric flow information supplied by flow sensor 124 for purposes of determining desired timing for replacement of filter elements 104a, 104b, 104c.

Regardless of the operating state of the reduced pressure water filtration system 100, either a flow mode or non-flow mode, the reduced pressure water filtration system 100 remains vented to atmosphere through either of filtered water outlets 112a, 112b. As such, reduced pressure water filtration system 100 never experiences a line pressure condition. In addition, reduced pressure filtration system 100 never experiences a static pressure condition during a non-flow condition, wherein the components downstream from the inlet valve 118 experience pressure above atmospheric pressure. During a dynamic pressure condition or flow condition, the reduced pressure water filtration system 100 experiences a typical pressure drop throughout the system based upon design of the inlet valve 118, the flow paths through the distribution manifold 102, the selected media and potential fouling or plugging of the filter elements 104a, 104b, 104c and the flow paths to the various points of use. By effectively eliminating the potential of static pressure condition, potentially approaching line pressure conditions, within the reduced pressure water filtration system 100, the components of the reduced pressure water filtration system 100 can be designed for lower pressure operating condition and the life of the reduced pressure water filtration system 100 can be extended.

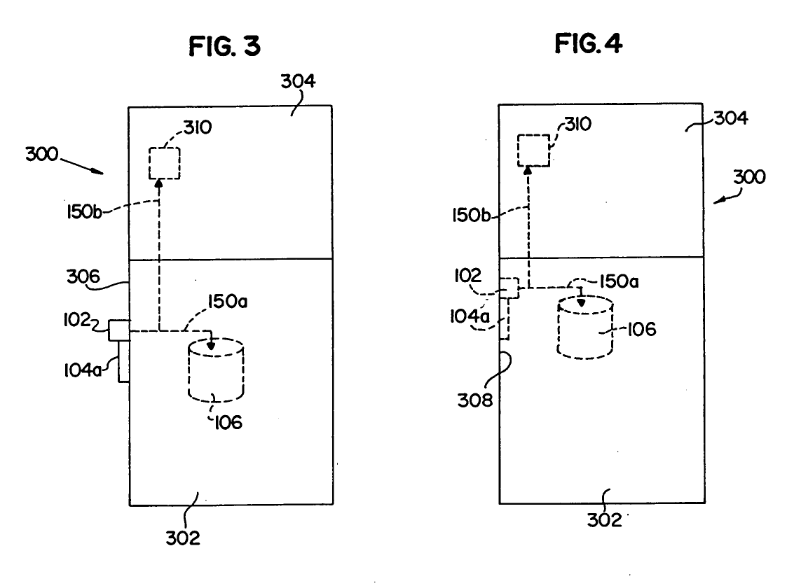

Representative installation configurations for reduced pressure water filtration system 100 are illustrated in FIGS. 3 and 4. Reduced pressure water filtration system 100 can be integrally mounted to and included with an appliance such as a refrigerator 300. Refrigerator 300 comprises a refrigerated portion 302 and a freezer portion 304. As shown in FIG. 3, the distribution manifold 102 and filtration elements such as filtration element 104a can be mounted on an exterior wall 306 of refrigerator 300. In an alternative arrangement as shown in FIG. 4, the distribution manifold 102 and filtration element 104a can be operably mounted to an interior wall 308 within the refrigerated portion 302. Without regard to the mounting orientations shown in FIGS. 3 and 4, the filtered water can be directed from the distribution manifold 102 and through outlet tubing 150a to storage tank 106 or through outlet tubing 150b and into an icemaker 310.

Reduced pressure water filtration system 200 of the present invention functions similarly to reduced pressure water filtration system 100 with a primary difference being that filter elements 204a, 204b, 204c are in parallel operation as opposed to serial operation as previously described. Through parallel operation, filter elements 204a, 204b, 204c simultaneously filter water such that the overall flow capacity of the reduced pressure water filtration system 200 is increased. In this manner, overall flow capacity for the reduced pressure water filtration system 200 can be increased while providing the benefits of increased contact time within each of the filter elements 204a, 204b, 204c.

While the systems shown in FIGS. 1 and 2 do not have a valve down stream from the filters that can close off atmospheric pressure, a down stream valve can be included in the system. Such a downstream valve can be a manual valve, such as a ball valve, or an automatic valve such as those valves described above. A manual valve can be closed during shipping or other time of inactivity or maintenance. However, a manual valve should be opened prior to use. Similarly, an automatic valve should be open whenever the inflow valve is to be opened such that the filters are never exposed to line pressure in a static flow environment. Thus, the systems are designed such that the filters only see line pressure under a dynamic flow environment at pressures somewhat less than static line pressures. The actual pressures at the filters depend on the flow rates through the filters and outlet portions of the system. Nevertheless, by not subjecting the filters to static line pressure, the pressure environment of the filters is significantly moderated relative to other designs such that the design parameters of the filters can be correspondingly relaxed.

Although various representative embodiments of the present invention have been disclosed here for purposes of illustration, it should be understood that a variety of changes, modifications and substitutions may be incorporated without departing from either the spirit or scope of the present invention.

1. A reduced pressure water filtration system comprising:
an inlet valve;
a manifold having an inlet, a flow channel and an outlet, the flow channel comprising at least one filter connection; and
at least one cartridge filter comprising a housing, an enclosed filtration media and a filter connector,
wherein the filter connector sealingly engages the filter connection to define a fluid circuit fluidly connecting the inlet and the outlet,
wherein the inlet valve is configured to control flow to the inlet, and
wherein the outlet is open to atmosphere in modes of operation when the inlet valve is open.

2. The reduced pressure water filtration system of claim 1, wherein the flow channel comprises at least two filter connections fluidly connected to at least two cartridge filters.

3. The reduced pressure water filtration system of claim 2, wherein the flow channel directs the supply flow through the at least two cartridge filters in a series flow configuration.

4. The reduced pressure water filtration system of claim 2 wherein the flow channel directs the supply flow through the at least two cartridge filters in a parallel flow configuration.

5. The reduced pressure water filtration system of claim 1, wherein the inlet valve comprises a flow orifice for reducing a supply pressure and a supply rate.

6. The reduced pressure water filtration system of claim 1, wherein the at least one cartridge filter is adapted for rotatable interconnection with the filter connector.

7. The reduced pressure water filtration system of claim 1, comprising a control unit operably connected to the inlet valve, the control unit selectively opening and closing the inlet valve based on a system input to the control unit.

8. The reduced pressure water filtration system of claim 7, wherein the system input comprises a manual input or an automated input.

9. The reduced pressure water filtration system of claim 7, wherein the outlet comprises a diverter valve operably connected to the control unit, the diverter valve defining at least two outlet flow paths wherein at least one of the outlet paths is open to atmosphere and wherein the control unit selectively directs a filtered water flow through the outlet flow paths.

10. The reduced pressure water filtration system of claim 7, wherein the outlet is fluidly connected to an upper portion of a storage tank, the storage tank comprising a storage volume for storing filtered water and a dispensing circuit for selectively dispensing the filtered water, the storage tank further comprising a level sensor operably connected to the control unit such that inlet valve selectively opens and closes based upon a tank level.

11. The reduced pressure water filtration system of claim 9, wherein the storage tank comprises a proximity sensor operably connected to the control unit such that the control unit prevents water flow to the storage tank if the storage tank is removably detached from the reduced pressure water filtration system.

12. The reduced pressure water filtration system of claim 10, wherein the storage tank comprises a removable pitcher.

13. The reduced pressure water filtration system of claim 7, wherein the outlet is fluidly connected to an icemaker.

14. The reduced pressure water filtration system of claim 1, wherein the enclosed filtration media comprises powdered and granular activated carbon media, ceramic filtration media, powdered polymeric filtration media, manganese greensand, ion exchange media, cross flow filtration media, polymeric barrier filtration or media, mineral-based fibers, granules and powders.

15. An appliance comprising a cooling compartment and the reduced pressure water filtration system of claim 1.

16. The appliance of claim 15, wherein the at least one cartridge filter is mounted outside of the cooling compartment.

17. A method for eliminating a static pressure condition within a water filtration system comprising:
venting a downstream side of the water filtration system to atmosphere such that a water flow pressure within the water filtration system is dissipated upon the closure of an upstream supply valve.

18. The method of claim 17, further comprising:
positioning the upstream supply valve in a flow configuration or a non-flow configuration based upon a demand input to the water filtration system.

19. The method of claim 18, wherein venting the downstream side of the water filtration system comprises selectively positioning a downstream diverter valve to direct a water flow through a distribution circuit based upon the demand input.

20. The method of claim 19, further comprising:
directing the water flow through the distribution circuit to a removable pitcher such that the removable pitcher is filled with filtered water to a desired storage level.

21. The method of claim 20, further comprising:
dispensing the filtered water in the removable pitcher by detaching the removable pitcher from the distribution circuit and pouring the filtered water from the removable pitcher.

22. A reduced pressure water filtration system comprising:
an inlet valve;
a manifold having an inlet, a flow channel and an outlet, the flow channel comprising at least one filter connection;
at least one cartridge filter comprising a housing, an enclosed filtration media and a filter connector, and
a storage tank fluidly connected to the outlet;
wherein the filter connector sealingly engages the filter connection to define a fluid circuit fluidly connecting the inlet and the outlet,
wherein the inlet valve is configured to control flow to the inlet, and
wherein the outlet is open to atmosphere in modes of operation when the inlet valve is open.

23. An appliance comprising a cooling compartment and a water filtration system, the water filtration system comprising:
a manifold having an inlet, a flow channel and an outlet, the flow channel comprising at least one filter connection;
at least one cartridge filter comprising a housing, an enclosed filtration media and a filter connector;
a flow control valve operably connected to the manifold to control flow through the manifold; and
a removable fluid reservoir fluidly connected to the outlet and in thermal contact with the cooling compartment;
wherein the filter connector sealingly engages the filter connection to define a fluid circuit fluidly connecting the inlet and the outlet.
